(19) United States
(12) Patent Application Publication
(10) Pub. No.: US 2005/0052672 A1
(43) Pub. Date: Mar. 10, 2005

(54) Method and system to seamlessly capture and integrate text and image information

(76) Inventors: Srikrishna Talluri, Southfield, MI (US); Pandurangarao Jetti, Hyderabad (IN)

Correspondence Address: SRIKRISHNA TALLURI;APT # 121, 23730 POND ROAD, SOUTHFIELD, MI, 48034, US

(21) Appl. No.: 10/881,886

(22) Filed: Jun. 30, 2004

Related U.S. Application Data
(60) Provisional application No. 60/483,859, filed on Jun. 30, 2003.

(51) Int. Cl. G06F 15/00

(52) U.S. Cl. 358/1.12; 358/1.18

(57) ABSTRACT

A method and system to capture data being printed onto a document along with an image of content pre-existing on the said document, during the printing process—while the document passes through a printing device is described. This involves the incorporation of one or more scanning elements with the printing element in a printing device. The data and images captured are then integrated as a single entity. Specific and relevant information from the entity thus formed is stored into a separate log/record and used for quality control and validation purposes. The log also enables the creation of metadata for the document that was printed.

### CROSS-REFERENCE TO RELATED APPLICATIONS

This application claims the benefit of priority of U.S. Provisional Patent Application Ser. No. 60/483,859, filed Jun. 30, 2003 and entitled “METHOD AND SYSTEM TO SEAMLESSLY CAPTURE AND INTEGRATE TEXT AND IMAGE INFORMATION”, the subject matter of which is hereby incorporated by reference herein.

### BACKGROUND OF THE INVENTION

This invention relates generally to the printing processes of data processing systems and, more specifically, to a method for seamless capture and integration of images and data passing through a printing device.

Data Retention and High Data Availability Regulations

Several government/official agencies have established regulations that mandate the retention of copies of accounting, tax and other financial and business documents for a specified minimum amount of time. Further, similar regulations also mandate high availability of consumer data for businesses that deal with consumer accounts such as banks, stockbrokers, credit card companies, other financial institutions etc.

While business was traditionally conducted using paper media (forms, agreements, other business documents etc.) and all documents were retained in the same paper format, most of the firms, nowadays, generate a lot of such documents in the electronic form and are moving towards retaining all documents (whether originally generated in paper or electronic forms) in the electronic format itself. Such retention in electronic format provides benefits such as remote access facilitation, easy searching for specific documents (by specific keywords) and quicker retrieval of the documents for the firm, its customers and the regulating agency. Another important benefit is that electronic copies are easily duplicated and the copy may be used to ensure high data availability by serving as a vital backup to protect against and assuage any data loss or damage to the original documents that might occur due to system or network failure or any other reasons.

Besides such mandated regulations, other concerns such as providing round the clock solutions to customers have driven firms to retain (in electronic form) other non-regulated, non-critical documents also as proof of business activity.

Data Format Conversion

The propensity exhibited by firms in storing copies of documents in electronic format has meant that a significant amount of time, effort and resources are expended in converting/formatting the generated documents into a suitable electronic format. Documents created on paper media are converted into suitable electronic format by using scanning machines, digital image capturing machines etc. Similarly, documents generated in the electronic form itself (using spreadsheets, word processing software etc.) are also often converted into images or other formats suitable for long term retention. Firms that specialize in offering services for converting documents into electronic formats suitable for long-term retention and maintaining an electronic archive, for other businesses, have now become commonplace.

Further, while the conversion of documents from one electronic format to another is a fairly straightforward process—with the use of specific software that enables automated conversion of several files at a time, the conversion of documents from paper form to an electronic format (despite the use of high-speed scanners) still remains a time-consuming and laborious one. The latter necessitates human involvement in the scanning process as well as for the potentially disruptive withdrawal and eventual re-filing of paper documents from and back to their respective folders. As such, it is in the interest of business owners to use a less disruptive process and avoid this burdensome process to the maximum extent possible.

Authentication Requirements

While an increasingly high percentage of documents are converted from one electronic format to another to facilitate long-term retention, it should be noted that despite the proliferation and usage of computers and word and data processing software, several documents whose content was created electronically are being output onto paper media. These paper documents are then being re-converted back to electronic format for long-term data retention and archival purposes. An analysis of the causes that necessitate such a process revealed that several documents need either documentary authentication (such as printout on official, preprinted documents like corporate letterheads or corporate checks) or human authentication (such as signatures) for legitimacy to achieve their intended purpose.

For corporations that periodically send out huge volumes of dividend checks to their shareholders or rebate checks to their customers (where data pertaining to a specific individual is printed onto authentic, preprinted checks bearing corporate information) the process of outputting the document onto paper media and their subsequent conversion back into electronic format for data retention purposes—can be truly onerous. Several other business owners and individuals who send out documents on preprinted business or personal letterheads etc. also face the same onerous tasks.

While human authentication can now be provided directly by capturing human signatures during the creation of the electronic document itself (using a signature pad), the printing of data onto preprinted official documents such as checks and letterheads might be a necessity for security reasons (as the checks might contain security features such as watermarks, silver security strips in the very paper on which the check is printed, MICR features and carry a higher degree of perceptible authenticity to prevent counterfeiting) or for aesthetic reasons (special embossing, higher printing/color quality etc. of letterheads).

Another problem pertains to the creation of a record that validates the execution of a business activity. In the above example, such a record could be made up of information from documents, already converted from paper to electronic format, which identifies them individually. Such records may be composed of information such as check number, check date, name of recipient, check validity ending date, amount of money issued etc. When such identifying information from the documents is gathered after the occurrence of an event (printing of checks), such tabulated data would act as proof that checks were processed for specific individuals with the corresponding check number(s) etc. The records also enable the search and retrieval of the scanned data by specific keywords (as the tabulated data could be stored in text format while the image of the entire check perhaps still remains as an image file) and also facilitate statistical calculations using spreadsheets (perhaps to calculate and double-check the total amount of money issued on a specific day or money actually issued to a specific individual etc.) and for error checking. While existing technology enables the automatic yet elementary indexing of scanned documents, such automatic tabulation/logging of pertinent identifying information still remains unaddressed.

The creation of a record may also be used as a final, automated quality check process to check for duplicated documents, improperly printed or incompletely printed ones from further processing. For instance, a duplicate check may have been erroneously issued to the same person or the amount to be issued might have been incorrectly printed or not printed at all. A comparison of the record thus created might be verified against the master file or simple checkpoints may be built into the tabulated log to identify potential errors in a timely manner, such as (for instance) before the checks are mailed out.

As such, it is desirable to overcome present limitations that lead to such roundabout, burdensome processes described above.

### BRIEF SUMMARY OF THE INVENTION

Accordingly, it is an object of the present invention to provide a method and system to capture and integrate images and data passing through a printing device.

It is another object of the present invention to automatically create a log of specific information from the documents passing through and being outputted from a printing device.

It is yet another object of the present invention to provide a business activity validation process.

It is still yet another object of the present invention to provide an automated quality check process after the completion of the business activity.

It is still yet another object of the present invention to automatically generate metadata for the outputted document.

### BRIEF DESCRIPTION OF THE SEVERAL VIEWS OF THE DRAWING

FIG. 1A, 1B, 1C and 1D are block diagrams illustrating prior art methods of scanning apparatus.

FIG. 2 is a block diagram of an embodiment illustrating a method of capturing and integrating images and data in accordance with the present invention.

FIG. 3 is a diagram illustrating a data capturing transaction in the creation of a validating log of business activity in accordance with the present invention.

FIG. 4 is an example of a log of business activity in accordance with the present invention.

FIG. 5 is a block diagram of another embodiment illustrating a method of capturing and integrating images and data in accordance with the present invention.

A scanner is a device that transforms a printed image from a source object into an identical digital image for display on a monitor or for further processing. Scanners are generally used to create digital images from books, magazines, newspapers, business cards, printed text, handwritten text or graphics, fabrics, flat objects etc. Scanners achieve this objective by converting light (analog form) reflected by a source object (e.g. photograph) into digital binary data (zeroes and ones) by using photosensitive cells (sensors) that relatively move over the source object capturing light levels reflected off the same. The light levels determine the electric current the sensor sends to ‘Analog to Digital’ (A/D) converter, which then forms the identical digital image.

Several types of scanners are currently available to handle different jobs. Some scanners are designed only for source objects of specific media, while others give higher quality scans and others are designed to occupy a very small space.

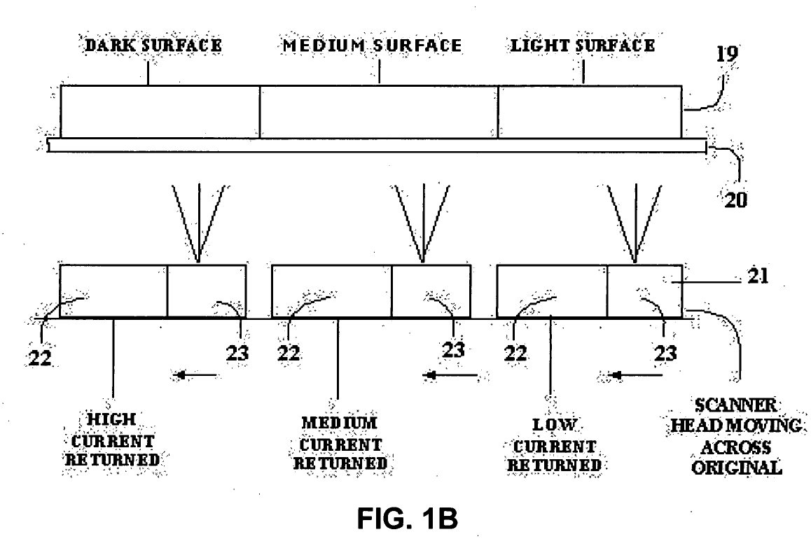

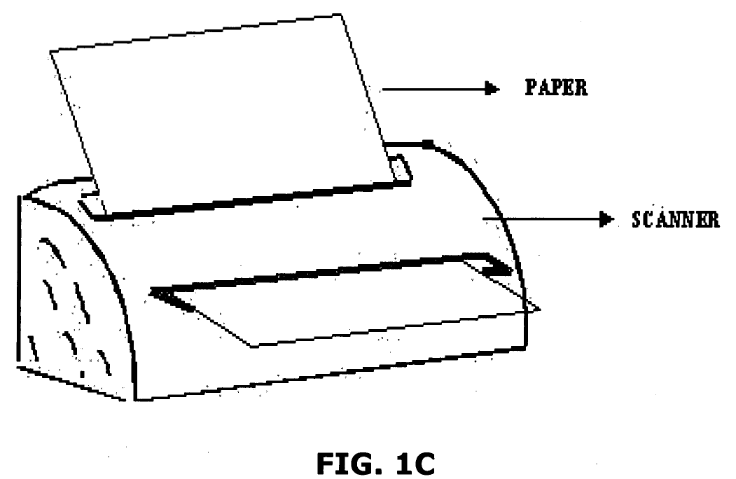

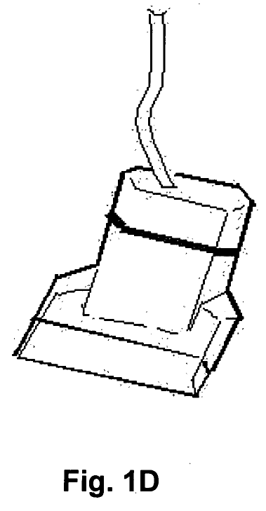

Referring to FIG. 1A and 1B, which are diagrams of a flatbed scanner that comprises of a document cover 10, a document pad 15, a glass screen 20, a ruler 25 and panel buttons 30. In FIG. 1B: 19 represents a source document, 20 represents a glass screen and 21 represents a scanner head which comprises of a sensor 22 and a lamp 23.

The source object is placed face down on the glass screen 20. The scanning head, which consists of a lamp and a sensor is placed beneath the glass screen and travels the length of the screen, illuminating the glass screen (i.e. the document placed on it). The sensor receives the light reflected by the document and then sends a corresponding electric current to the ‘Analog to Digital’ converter.

Referring to FIG. 1C, which is a diagram of a sheet-fed scanner where the document to be scanned is moved across a fixed sensor. Sheet-fed scanners generally take up less space than a flatbed.

Referring to FIG. 1D, which is a diagram of a handheld scanner where the T-shaped hand scanner is held in the hand and manually dragged over the image that is to be scanned. Sensors placed in the bottom of handheld scanner register the image through a transparent window to generate the digital image.

While the flatbed scanner used a moving scanner head to scan the document, the sheet-fed scanner moves the documents across the fixed scanner head to achieve the purpose. In a handheld scanner the moving force is provided manually to move the sensor over the image. However, all the above scanner types are used for reflective media.

To scan transparent media, the illuminating source is placed on one side of the transparent source document and the sensors are placed on the other side i.e. the sensors register the light transmitted through the source document rather than the light reflected from it.

Drum Scanners currently handle both transparent and reflective media. The source document is fastened to a cylindrical scanner drum and the drum rotates at high speeds while a bright laser light is illuminated onto the document.

### DETAILED DESCRIPTION OF THE INVENTION

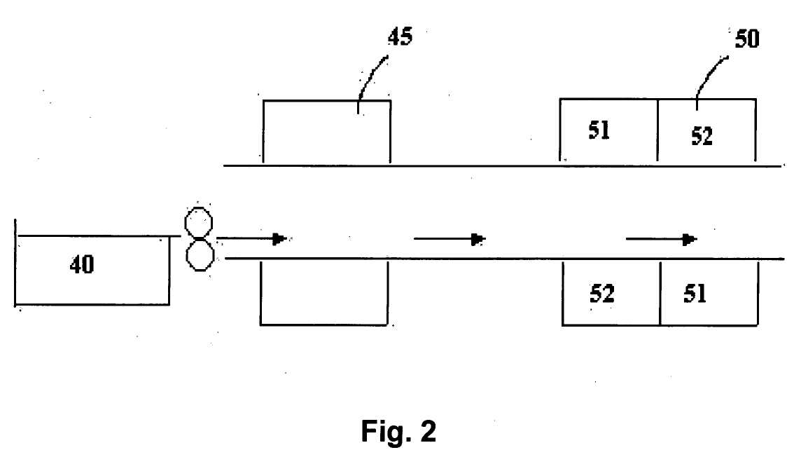

FIG. 2 is a block (longitudinal section) diagram illustrating the preferred embodiment of the present invention. It comprises of a tray 40 that holds the preprinted sheets (target document), a printing element 45 and a scanning element 50.

The scanning element 50 is made up of two scanning heads, placed above and facing each other. Each scanning head further consists of a lamp 51 and a sensor 52. It should be noted that the lamp on the lower scanning head is lined up with the sensor on the one above it while the sensor on the lower one is lined up with the lamp on the upper scanning head.

The primary purpose of the scanning element and the unique placement of the lamps and the sensors (within the two scanning heads) are to provide the ability to scan either a reflective (opaque) or transparent preprinted sheet as well as the ability to scan both sides of a document in a single operation. An option of using either or just one of the scanner heads would be provided to the user or may be determined by the system. The user may decide to use just a single scanner head for capturing data from a single side of reflective documents or use both the scanner heads to capture data from both sides of reflective documents.

When a transparent media is used, both the sensors would receive light from the lamp on the other scanner head and hence this may lead to the generation of two identical images. To avoid the same, light emitted by each lamp carries an identifying signature, which can be distinguished by the sensors. When the sensors recognize that light is being received from the lamp on the opposing scanner head, the systems either shuts off/disables one lamp or sensor or discards one of the two images thus formed.

The preprinted paper in the tray 40 is both the target (for the printing element) and the source document (for the scanning element). Arrows depict the path of the preprinted sheet. As the sheet moves through the printing element, the data sent by the computer to be printed is now printed onto the sheet. As the sheet moves further along and begins its passage through the scanning element, the lamps 51 emit light onto the document. If the sheet is reflective, the light is reflected back to the sensor 52 (on the same side as the lamp). As described in the previous section, the light levels received by the sensors determine the electric current sent to the A/D converter, which forms the identical digital image.

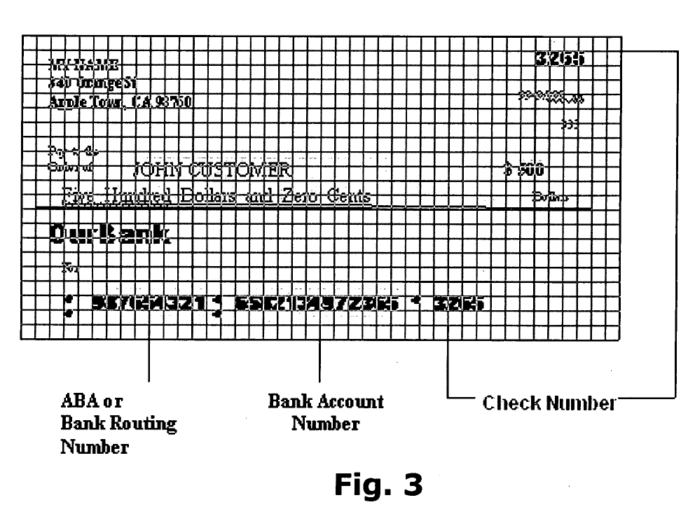

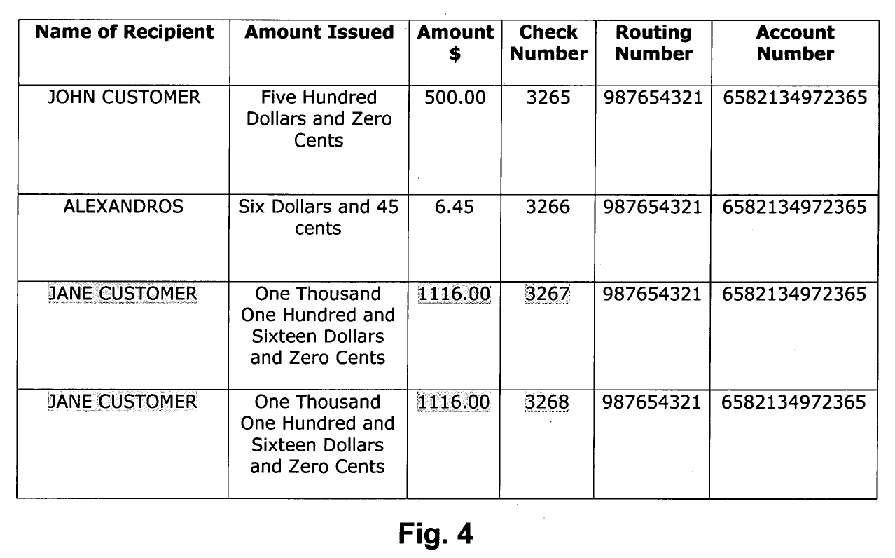

FIG. 3 and FIG. 4 show the creation of a log of the performed transaction. In FIG. 3, a grid is superimposed onto the digital image to capture critical information. For documents with identical formats such as checks, a template grid may be setup to indicate the specific location (block of data) on following checks from which information must be captured. For instance, if the log is to be made up of the name of recipient, amount issued (spelled out as text e.g. Five hundred dollars), amount (in figures e.g. $500), check number, ABA Routing number and account number, all these locations on the check are highlighted on the template check and directed to be put into specific data fields in the log (FIG. 4). Optical Character Recognition (OCR) may be used to convert the images placed into these data fields into text or numeric format.

Further, the generation of a log could be done for documents or checks of similar format but of different sizes by superimposing the grid onto the document and identifying the specific data (blocks) to be captured as a percentage of size compared to the actual size of the check.

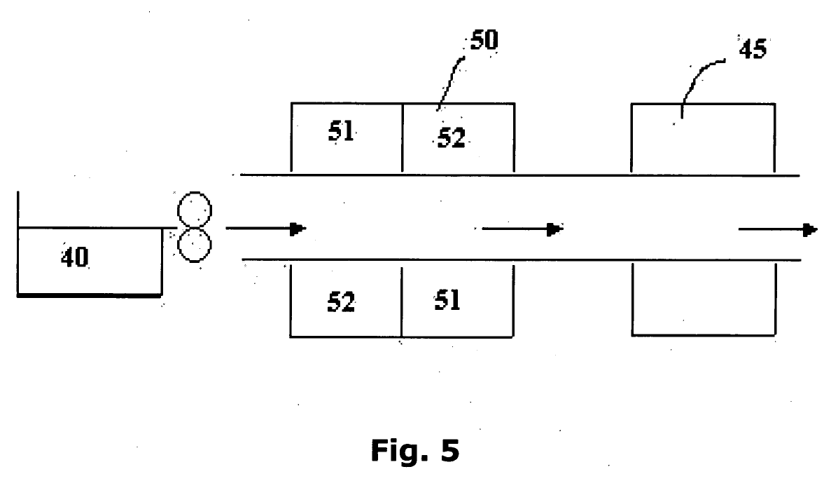

In the second embodiment of the present invention, the scanning element is placed further upstream i.e. before the printing element as shown in FIG. 5. Here, the digital image of the preprinted sheet is captured prior to the data being printed on it. The system receives an exact copy of the data being sent by the computer to the printing element with all its settings (such as font, font size, margin settings etc.) and virtually superimposes the data onto the digital image captured by the scanning element. The image would now be a true virtual copy of how the actual document would appear after being printed upon, considering that the print element successfully printed the data onto the check. The advantage of this process is that any idle time before the print element receives the data from the computer may be used up (to increase productivity) and the scanning step after printing may be avoided. The generation of the log is done as explained above.

In the foregoing specification, the invention has been described with reference to an illustrative embodiment thereof. However, it will be evident that various modifications and changes may be made thereto without departing from the broader spirit and scope of the invention. The specification and drawings are, accordingly, to be regarded in an illustrative rather than a restrictive sense. Therefore, it is the object of the appended claims to cover all such modifications and changes as come within the true spirit and scope of the invention.

1. A method and system that captures data being printed onto a document along with an image of content already present on the said document during the printing process, while the document passes through a printing device and integrates the captured data and images.

2. A method of claim 1, where one or more scanning elements are used in conjunction with the printing element in a printing device.

3. A method of claim 1, where a record of specific information from the documents passing through and being outputted from a printing device is automatically created.

4. A method of claim 1, where metadata is automatically created for the outputted document.

5. A method of claim 1, where the document being printed is a check.

6. A method of claim 1, where the data being printed is an agreement between two or more parties onto a legally designated form with corresponding preprinted identification marks.

7. A method of claim 1, where information being submitted by a specific entity makes up the data being printed onto a designated form with a predefined format containing preprinted specific identifiers for each item of information being printed.
